(19) United States
(12) Patent Application Publication
(10) Pub. No.: US 2025/0232225 A1
(43) Pub. Date: Jul. 17, 2025

(54) MANAGEMENT OF FEDERATED LEARNING IN 5G SYSTEM

(71) Applicant: Yizhi Yao, Chandler, AZ (US)

(72) Inventor: Yizhi Yao, Chandler, AZ (US)

(21) Appl. No.: 19/097,624

(22) Filed: Apr. 1, 2025

Related U.S. Application Data
(60) Provisional application No. 63/574,007, filed on Apr. 3, 2024.

(51) Int. Cl. G06N 20/00

(52) U.S. Cl. CPC G06N 20/00

(57) ABSTRACT

Systems and methods are disclosed for Federated Learning (FL) in 5G systems. The FL enables collaborative machine learning (ML) across distributed data sources without exchanging raw data. The management framework includes an ML training function acting as FL server that aggregates local models from multiple ML training functions acting as FL clients. The FL clients train models locally and share only model parameters with the server at configured intervals. The management system provides capabilities for discovering FL roles, selecting appropriate FL clients based on training requirements, monitoring performance of global and local models, and tracking client contributions to the FL process. Authentication procedures between FL server and clients ensure secure model exchange.

### PRIORITY CLAIM

This application claims the benefit of priority to U.S. Provisional Patent Application Ser. No. 63/574,007, filed Apr. 3, 2024, which is incorporated herein by reference in its entirety.

### TECHNICAL FIELD

Embodiments pertain to wireless networks and wireless communications. Some embodiments relate to management of federated learning in a 5^{th} generation system (5GS).

### BACKGROUND

Mobile communication has evolved significantly from early voice systems to highly sophisticated integrated communication platform. Next-generation (NG) wireless communication systems, including 5^{th} generation (5G) and sixth generation (6G) or new radio (NR) systems, are to provide access to information and sharing of data by various UEs and applications. NR is to be a unified network/system that is to meet vastly different and sometimes conflicting performance dimensions and services driven by different services and applications. As such, the complexity of such communication systems, as well as interactions between elements within a communication system, has increased. In particular, with the permeation of artificial intelligence/machine learning (AI/ML) into all aspects of technology, the use of AI/ML models is to be integrated into NR systems.

### BRIEF DESCRIPTION OF THE DRAWINGS

The present disclosure is illustrated by way of example and not limitation in the figures of the accompanying drawings, in which like references indicate similar elements and in which:

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates decentralized ML training functions for Federated Learning in accordance with some aspects.

FIGS. 4A and 4B illustrate ML training management service frameworks in accordance with some aspects.

FIG. 5 illustrates an ML model method to be performed by a management service (MnS) producer in accordance with some aspects.

FIG. 6 illustrates an ML model method performed by an MnS consumer in accordance with some aspects.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

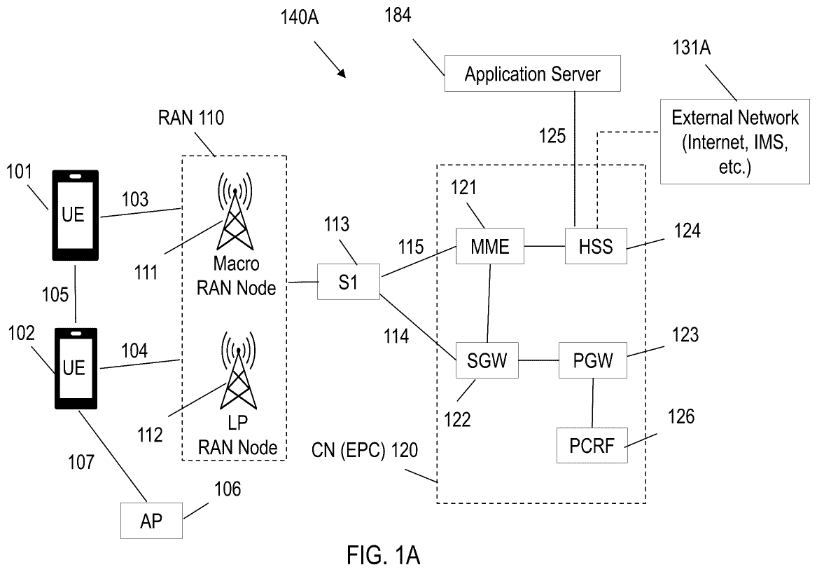

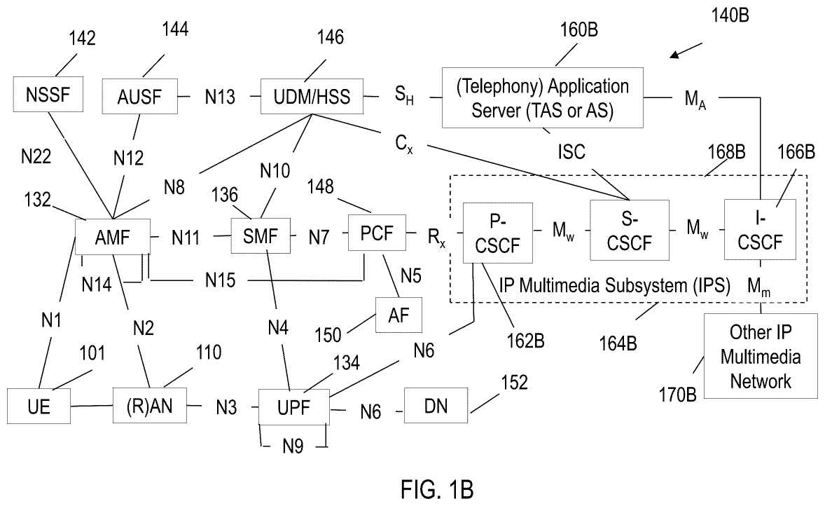

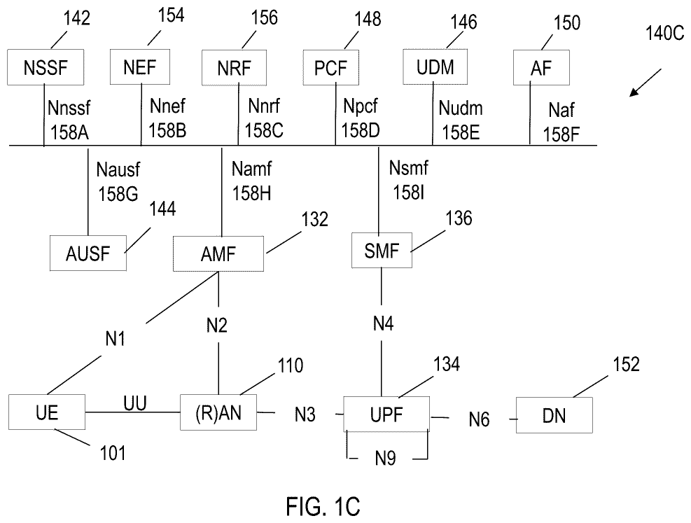

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a master node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

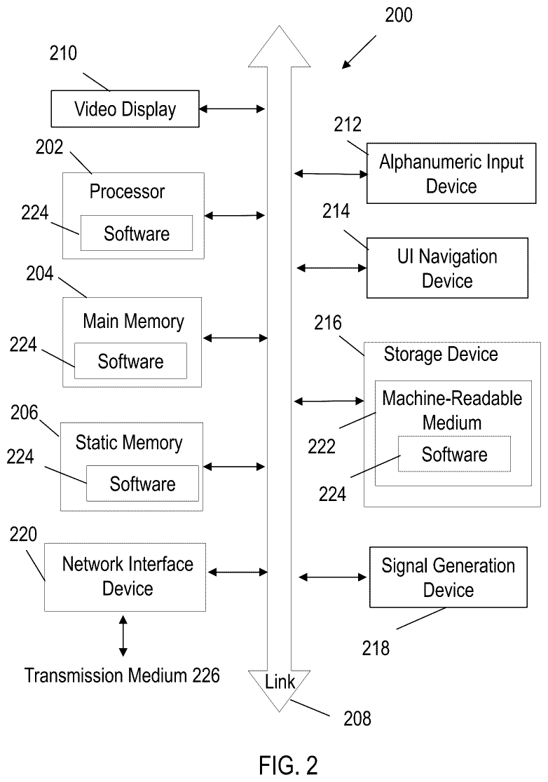

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth (r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, the use of ML models has become ubiquitous throughout a wide variety of technologies. In general, ML models are developed and trained using historical data prior to using the ML model to generate predictions or inferences based on new input data. Different techniques may be used to train the ML model, including Federated Learning.

Federated Learning is a distributed machine learning approach that allows multiple ML training functions to collaboratively train an ML model on local datasets contained in each ML training function without explicitly exchanging data samples.

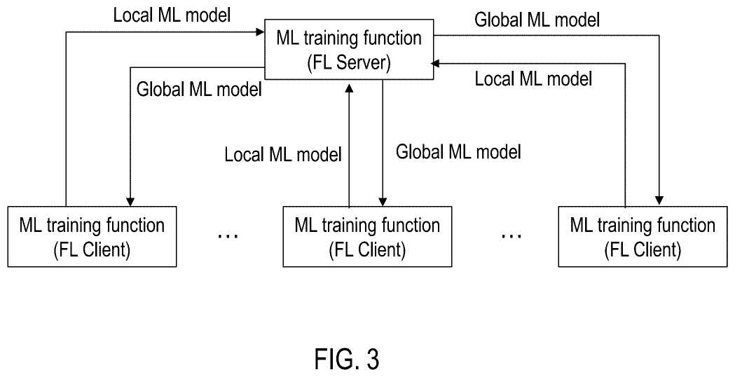

Federated Learning is supported by a group of ML training functions, which contains an ML training function acting as a Federated Learning server and multiple ML training functions acting as Federated Learning clients. The Federated Learning client retains the localized data and maintains privacy of the data. The Federated Learning trains the ML model directly on the local nodes (client) where the data is generated or stored. The Federated Learning client reports the local ML model to the Federated Learning server at a predetermined frequency. The Federated Learning server aggregates the local ML models received from Federated Learning clients to generate a global ML model. The global ML model is then shared with all Federated Learning clients. FIG. 3 illustrates decentralized ML training functions for Federated Learning in accordance with some aspects.

Federated learning in general can be categorized into two main types: Horizontal Federated Learning (HFL) and Vertical Federated Learning (VFL), based on the nature of the data distribution and the way the model training is orchestrated among participants. For HFL, the process typically includes Federated Learning Client discovery and selection, local ML model training and updates by the Federated Learning Clients, ML model updates aggregation, and global ML model distribution by the FL Server.

Federated Learning is thus a decentralized machine learning approach where multiple devices or clients collaboratively train a model without sharing their raw data with a central server. Instead, each device trains the model locally using its own data and only shares model updates, such as weights and biases, with the server. The server then aggregates the updates to improve the global model, which is subsequently redistributed to the devices for further training.

### ML Training Management Service Framework

The ML training is managed via a Management Service (MnS) provided by a ML training MnS producer to a consumer. An MnS Producer is part of the 3GPP Service-Based Management Architecture (SBMA) that provides management capabilities for various functions. The MnS Producer is responsible for executing tasks such as training, validation, testing, and inference of ML models based on requests from Management Service consumers (MnS consumers). The MnS producer can initiate ML training or respond to consumer requests, manage training data, and evaluate model performance. The MnS producer also handles tasks like inference emulation and orchestration, ensuring that ML models are optimized and deployed effectively within the network or system. In essence, the MnS producer acts as a facilitator for AI/ML management processes, translating consumer intents into actionable tasks and providing results or updates back to the consumers.

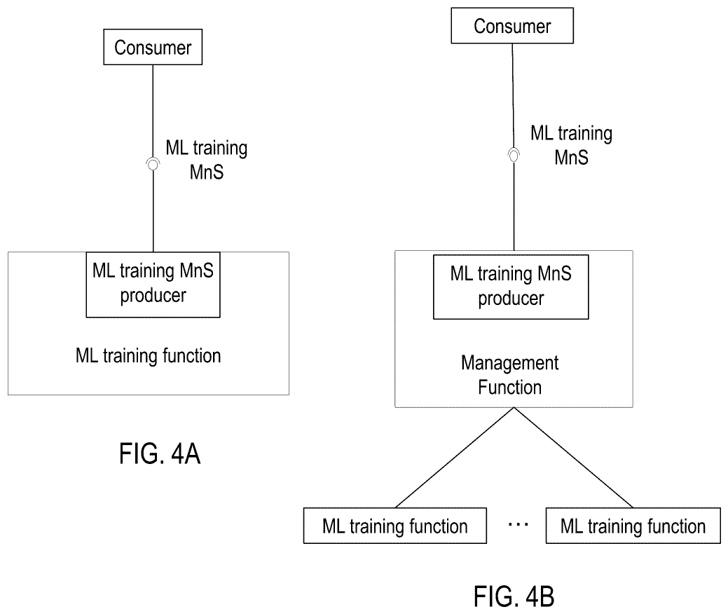

FIGS. 4A and 4B illustrate ML training management service frameworks in accordance with some aspects. The MnS producer is either located in the ML training function as shown in FIG. 4A, or in a management function which manages one or more ML training function(s) as shown in FIG. 4B. The Federated Learning is managed via the ML training MnS by the consumer through the producer.

### Capabilities for Managing Federated Learning for 5GS

When Federated Learning is used in 5GS, such as by a Network Data Analytics Function (NWDAF), an ML model is collaboratively trained by a group of ML training functions including one acting as a Federated Learning server and the others acting as Federated Learning clients.

The NWDAF is designed to collect, analyze, and utilize data from various network functions and external sources to generate actionable insights. The NWDAF gathers data from 5G Core Network Functions (NFs), Application Functions (AFs), and Operations, Administration, and Maintenance (OAM) systems. This data includes metrics, events, and management statistics. The NWDAF performs advanced analytics, including ML modeling, to provide insights into network performance, security, and optimization. This enables operators to make data-driven decisions. The NWDAF delivers analytics information to other NFs and AFs, supporting intelligent decision-making for tasks like resource management, network optimization, and service assurance. The NWDAF supports ML model training and provisioning, enabling predictive analytics and anomaly detection to enhance network automation and efficiency.

The NWDAF provides network performance monitoring, in which the NWDAF tracks metrics like latency, throughput, and resource availability to identify and troubleshoot performance issues. The NWDAF also provides security analysis, detecting potential threats by analyzing network traffic patterns. In addition, the NWDAF provides network optimization, enhancing resource utilization and cost efficiency by predicting and addressing network inefficiencies. The NWDAF also provides service assurance, ensuring Quality of Experience (QoE) and Quality of Service (QOS) for end-users by automating service performance management.

As depicted in FIG. 3, each ML training function acting as Federated Learning client trains the ML model locally using the local data set, and reports the trained local ML model to the ML training function acting as Federated Learning server at a predetermined frequency. The Federated Learning server generates the global ML model by aggregating the received local ML models and shares the global ML model with all Federated Learning clients.

For managing the Federated Learning, the ML training MnS consumer determines the group of ML training functions involved in the Federated Learning and the role (Federated Learning server, Federated Learning client) of each ML training function. This permits the consumer to determine the impact of ML training function and can manage the ML training function correspondingly.

To evaluate the performance of each ML training function and trained ML model, the consumer determines the relation between the global ML model and the local ML models, and their training performance. For instance, if a Federated Learning server is unable to generate a global ML model with better performance than a local ML model for running on a distributed node, the consumer may instruct the MnS producer to take one or more predetermined actions to optimize the Federated Learning through, for example, adjustment of the load to the local ML models, adding or removing one or more Federated Learning clients, or vary parameters for selection of Federated Learning clients (e.g., performance related).

The frequency of the ML model exchange between the Federated Learning client and the Federated Learning server impacts not only the model performance but also the energy consumption and resource usage of the Federated Learning client and server. Therefore, the 3GPP management system may be configured to permit the consumer to control the frequency of the model exchange while monitoring the model performance (in training, testing, emulation and inference phases), energy consumption and resource usage.

The capabilities exposed by the ML training MnS producer for managing Federated Learning include:

REQ-FL_MGMT-1: The ML training MnS producer has the capability of allowing an authorized consumer to obtain information about whether an ML training function is involved in Federated Learning.

REQ-FL_MGMT-2: The ML training MnS producer has the capability of allowing an authorized consumer to obtain the role (Federated Learning sever or Federated Learning client) of an ML training function in Federated Learning.

REQ-FL_MGMT-3: The ML training MnS producer has the capability of allowing an authorized consumer to obtain the relation between the ML training functions in Federated Learning.

REQ-FL_MGMT-4: The ML training MnS producer has the capability of allowing an authorized consumer to obtain information about the local ML models trained by the ML training function acting as a Federated Learning client.

REQ-FL_MGMT-5: The ML training MnS Federated Learning has the capability of allowing an authorized consumer to control the frequency of ML model exchange between the ML training function acting as a Federated Learning client and the ML training function acting as a Federated Learning server.

REQ-FL_MGMT-6: The ML training MnS producer has the capability of allowing an authorized consumer to obtain information about the global ML model generated by the ML training function acting as a Federated Learning server.

REQ-FL_MGMT-7: The ML training MnS producer has the capability of allowing an authorized consumer to obtain information about the relation between the global ML model and the local ML models.

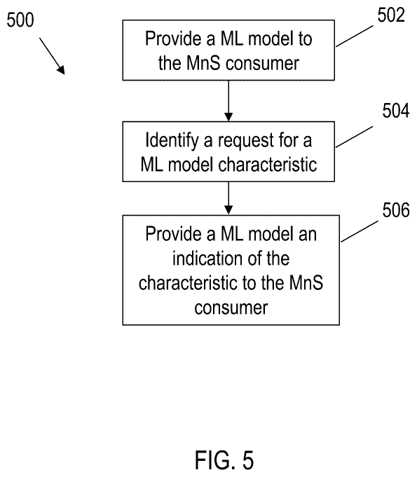

In some embodiments, the electronic device(s), network(s), system(s), chip(s) or component(s), or portions or implementations thereof may be configured to perform one or more processes, techniques, or methods as described herein, or portions thereof. One such process 500 is depicted in FIG. 5, which illustrates an ML model method to be performed by an MnS producer, one or more elements of a MnS producer, and/or one or more electronic devices that include and/or implement a MnS producer. The process 500 may include providing, at operation 502 to a MnS consumer, a ML model. The ML model is generated by a Federated Learning server based on one or more local ML models provided to the Federated Learning server by one or more Federated Learning clients. At operation 504, the MnS producer may identify, from the MnS consumer, a request for a characteristic of the ML model. In response to the request, at operation 506 the MnS producer may provide to the MnS consumer, an indication of one or more characteristics of the ML model.

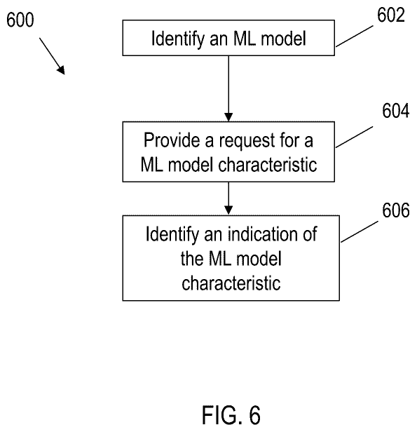

Another such process is depicted in FIG. 6, which illustrates an ML model method performed by an MnS consumer, one or more elements of a MnS consumer, and/or one or more electronic devices that include and/or implement a MnS consumer. The process 600 may include the MnS consumer identifying, at operation 602, an ML model from a MnS producer. The ML model is generated by a Federated Learning server based on one or more local ML models provided to the Federated Learning server by one or more Federated Learning clients. At operation 604, the MnS consumer may transmit, to the MnS producer, a request for a characteristic of the ML model. At operation 606, the MnS consumer may identify, from the MnS producer, an indication of one or more characteristics of the ML model.

In 5GS, the ML training function may be located within the management system or in the NF (e.g. gNB or NWDAF). Each training node has different computing resources and storage capacity based on physical infrastructure such as CPU/GPU/DPU, memory, storage, and network bandwidth. To obtain load balance between nodes and maximize the efficiency of resource utilization, the training may be split up and involve multiple training functions as distributed training that is to be supported in the management systems.

In 5GS, distributed training can apply across various deployment scenarios for the ML training function. These functions may be located within the 3GPP management system, domain-specific management functions (e.g., RAN or CN), or directly in NFs such as the gNB or NWDAF. When receiving an ML training request, the MnS producer may evaluate whether distributed training is to be used according to the training requirements provided by the ML training consumer, and it is up to the MnS producer to determine, based on a set of information (e.g., target inference location) provided by the consumer, appropriate training function(s) to participate in the ML model training. The training requirement may further include (not limited to) expected model performance. Collaboration, mutual agreement and authentication procedures are to be established between distributed ML training functions before sharing any information between these functions.

The actions of ML model distributed training may involve for example, splitting the training of an ML model across many ML training functions, each responsible for computing a portion of the ML models operations. Since the training data may be sparse, the MnS consumer may provide an indication that the training data should not be split while splitting the training among multiple training functions.

To manage Federated Learning, the ML training MnS consumer determines the Federated Learning clients and Federated Learning server involved in the Federated Learning, so that the consumer understands the impact of each of entity can manage the entity correspondingly.

When receiving an ML Training request, an ML Training MnS Producer evaluates whether Federated Learning process is to be started according to the training requirements (e.g., minimum number of Federated Learning clients, minimum number of total iterations, minimum number of data samples, and available time of the Federated Learning clients, fault tolerance, energy source and carbon emission information) provided by the ML training consumer. Based on the received requirements, the ML Training MnS Producer with the role of Federated Learning server may select (including by adding and removing) appropriate Federated Learning clients.

To evaluate the performance of Federated Learning, the consumer can query the performance of the final global ML model running on the local training data set of participating Federated Learning clients. For instance, if a Federated Learning server cannot produce a global ML model that is able to satisfy predetermined performance characteristics for the Federated Learning clients, the consumer may interact with (i.e., send instructions to) the MnS ML training producer to optimize the Federated Learning for future training, e.g., updating the criteria for selecting Federated Learning clients.

In addition, the consumer obtains information about the contribution of each Federated Learning client to the Federated Learning process. The consumer, in response to determining that the training (contribution) provided one or more Federated Learning clients is problematic, may instruct the MnS producer to remove the one or more Federated Learning clients, add one or more Federated Learning clients, or vary performance parameters for Federated Learning clients (such as frequency of global/local ML exchange, number of iterations used by the Federated Learning client participating in the Federated Learning, number of data samples the Federated Learning client used during an iteration, and training duration performed by the Federated Learning Client).

Federated Learning (FL) is a distributed machine learning approach that allows multiple ML training functions to collaboratively train an ML model on local datasets contained in each ML training function without explicitly exchanging data samples.

FL is supported by a group of ML training functions, which contains an ML training function acting as FL server and multiple ML training functions acting as FL clients. The FL client keeps the data localized and private, and trains the ML model directly on the local nodes (client) where the data is generated or stored. The FL client reports the local ML model to the FL server at some frequency, and FL server aggregates the local ML models received from FL clients to generate the global ML model and then shares with all FL clients.

Federated Learning enables privacy-preserving machine learning by allowing model training across distributed data sources without requiring the raw data to leave its original location. This approach addresses several technical challenges in 5G systems management:

Data Privacy Protection: FL maintains data sovereignty by keeping sensitive network data within its original location. For example, user equipment (UE) behavior patterns collected by a network data analytics function (NWDAF) remain within that function while still contributing to the overall learning process.

Communication Efficiency: FL reduces network bandwidth consumption by transmitting only model updates rather than raw data. In a scenario where multiple radio access network (RAN) nodes are training a mobility prediction model, each node only needs to share model parameters (weights and biases) rather than the complete dataset of user movement patterns.

Horizontal Federated Learning (HFL): This technique allows training when different FL clients have the same feature space but different samples. For instance, multiple gNBs in different geographical areas might collect similar types of radio measurement data but from different sets of users. These gNBs can participate in HFL to build a comprehensive coverage optimization model.

FL Server-Client Architecture: The management framework defines specific roles where:

FL Server: Responsible for aggregating local model updates and distributing the global model

FL Clients: Perform local training on their respective datasets and share only model parameters

Model Exchange Frequency Management: The system allows control over how often model updates are exchanged between clients and server, which affects both model performance and resource utilization. For example, a network operator might configure less frequent model exchanges during peak traffic hours to reduce computational load.

Performance Monitoring: The management system provides capabilities to evaluate both local and global model performance, allowing operators to identify which FL clients contribute most effectively to the global model. This enables optimization of client selection for future training rounds.

Authentication and Authorization: Prior to any model or parameter exchange, secure authentication procedures are established between FL server and clients to ensure only authorized entities participate in the training process.

The 3GPP management system implements these capabilities through specific requirements such as REQ-ML_TRAIN_FL-1 through REQ-ML_TRAIN_FL-6, which enable discovery of FL roles, provision of training requirements, selection of FL clients, performance monitoring, and reporting of client contributions to the FL process.

Thus, at a high level, FL represents a distributed ML approach in which multiple training functions collaborate to train models while preserving data privacy. In this approach, data remains at its source location while only model updates are exchanged between participants. The FL architecture includes a server that aggregates model updates and clients that perform local training. This approach enables privacy-preserving machine learning across distributed data sources without requiring raw data to leave its original location.

In more specific examples, FL in 5G systems involves a structured framework in which an ML training function acts as an FL server while multiple other ML training functions serve as FL clients. The FL clients maintain data locally and train ML models directly on the nodes where data is generated or stored. These clients then share their local ML models with the FL server at configured intervals. The server aggregates these local models to create a global ML model, which is then distributed back to all clients.

The management of FL in 5G systems is implemented through detailed technical requirements and capabilities. The ML training MnS producer provides interfaces that allow authorized consumers to discover FL roles (REQ-ML_TRAIN_FL-1), determine whether an ML training function is acting as an FL server or FL client, and understand the relationships between different ML training functions participating in the FL process. The system supports Horizontal Federated Learning (HFL), wherein local datasets in different HFL clients have the same feature space but different samples. For instance, when managing FL client selection, the MnS producer enables consumers to provide requirements for adding or removing FL clients (REQ-ML_TRAIN_FL-3), which might include minimum number of FL clients, minimum number of total iterations, minimum number of data samples, and available time of the FL clients. The management system also provides capabilities to monitor the performance of the global ML model on each participating FL client (REQ-ML_TRAIN_FL-4) and report detailed information about each client's contribution to the FL process, such as the number of iterations in which the client participated, the number of data samples used, and the training duration performed by each FL client (REQ-ML_TRAIN_FL-5).

In some examples, FL in 5G systems may implement a hierarchical aggregation approach where multiple levels of FL servers exist between the clients and the global server. This architecture allows for intermediate aggregation of model updates from geographically or logically related FL clients before final aggregation at the global FL server. For instance, ML training functions in the same geographical region might first aggregate their models at a regional FL server before those regional models are further aggregated at a global level. This could reduce communication overhead and improve scalability in large deployments.

In some examples, an asynchronous FL approach could be implemented where FL clients contribute model updates at their own pace rather than in synchronized rounds. This allows clients with varying computational capabilities or network conditions to participate effectively in the FL process without becoming bottlenecks. The ML training MnS producer may have additional capabilities to manage the asynchronous nature of model updates, including tracking which clients have contributed to the current global model version and determining when to generate new global model updates.

In some examples, a weighted aggregation mechanism may be implemented where the FL server assigns different weights to model updates from different FL clients based on factors such as data quality, quantity, or relevance. The ML training MnS producer may provide capabilities for authorized consumers to configure these weighting parameters or to receive information about how different clients' contributions are weighted in the global model. This allows for more sophisticated management of the FL process, particularly in heterogeneous environments where some clients may have more valuable data than others.

In some examples, a differential privacy approach may be integrated with FL to provide stronger privacy guarantees. This involves adding calibrated noise to model updates before they are shared with the FL server, preventing the extraction of information about individual data points while still allowing useful model training. The ML training MnS producer may use additional capabilities to manage privacy parameters such as noise levels and to monitor the privacy-utility tradeoff in the resulting models.

In some examples, a personalized FL approach may be implemented where, in addition to the global model, each FL client maintains a personalized model tailored to its local data distribution. The global model serve as a foundation, but each client may adapt the global model to better fit local conditions. The ML training MnS producer may use capabilities to manage both global and personalized models, including monitoring their respective performances and controlling the degree of personalization.

In FL, the model exchange process operates through a structured workflow between FL clients and the FL server:

Local Model Training: Each ML training function acting as an FL client trains the ML model locally using its own dataset.

Model Reporting: The FL client reports the trained local ML model to the ML training function acting as FL server at a configured frequency.

Global Model Aggregation: The FL server generates the global ML model by aggregating the received local ML models from all participating FL clients.

Model Distribution: The FL server shares the updated global ML model with all FL clients for the next round of training.

Iteration: This process repeats in cycles, with each iteration potentially improving the global model's performance.

### Management Operations

The ML training MnS producer facilitates management of this process through several operations:

FL Client Discovery and Selection: The MnS producer evaluates whether an FL process needs to be started according to training requirements provided by the ML training consumer. Based on these requirements, the ML Training MnS Producer with the role of FL server may select (including adding and removing) appropriate FL Clients.

Performance Evaluation: The consumer can query the performance of the final global ML model running on the local training data set of participating

FL clients. If an FL server cannot produce a global ML model with satisfactory performance for the FL clients, the consumer may interact with the MnS ML training producer to optimize the FL for future training.

Contribution Monitoring: The consumer receives information about the contribution of each FL client to the FL process, including the number of iterations in which the FL client participated, the number of data samples used, and the training duration performed by the FL Client.

Authentication and Authorization: A prior agreement and authentication procedures should be established between FL Server and FL clients before sharing any information between these functions.

The management system implements these capabilities through specific requirements such as REQ-ML_TRAIN_FL-1 through REQ-ML_TRAIN_FL-6, which enable discovery of FL roles, provision of training requirements, selection of FL clients, performance monitoring, and reporting of client contributions to the FL process.

### EXAMPLES

Example 1 is an apparatus of a management service (MnS) producer, the apparatus comprising a processor that configures the apparatus to: provide a management service to an MnS consumer to manage Federated Learning (FL) for a 5th generation system (5GS), the FL supported by a first machine learning (ML) training function acting as an FL server and a plurality of second training functions acting as FL clients, the FL clients configured to generate local ML models and provide the local ML models to the FL server, the FL server configured to generate a global ML model based on the local ML models and provide the global ML model to the FL clients for further training to produce revised local ML models, wherein the management service includes, providing to the MnS consumer an identification and a role of each of the first ML training function and second ML training functions.

In Example 2, the subject matter of Example 1 includes, wherein the MnS producer is disposed in at least one of the first or second ML training function.

In Example 3, the subject matter of Examples 1-2 includes, wherein the MnS producer is disposed in a management function that manages at least one of the first or second ML training functions.

In Example 4, the subject matter of Examples 1-3 includes, wherein the processor further configures the apparatus to provide, to the MnS consumer, characteristics of the FL on the first and second ML training functions to revise the FL in response to the global ML model having worse performance than an expected performance running on a local data set on at least one FL client.

In Example 5, the subject matter of Examples 1-4 includes, wherein the processor further configures the apparatus to: provide, to the MnS consumer, ML information that includes model performance in different ML phases, energy consumption and resource usage, and receive, from the MnS consumer, instructions to control a frequency of model exchange between the FL clients and the FL server based on the ML information.

In Example 6, the subject matter of Examples 1-5 includes, wherein the processor further configures the apparatus to expose, to the MnS consumer, capabilities for managing the FL that include obtaining information about whether a particular ML training function is involved in FL and a role of the particular ML training function in the FL.

In Example 7, the subject matter of Examples 1-6 includes, wherein the processor further configures the apparatus to expose, to the MnS consumer, capabilities for managing the FL that include obtaining relations between the first ML training function and the second ML training functions in the FL.

In Example 8, the subject matter of Examples 1-7 includes, wherein the processor further configures the apparatus to: receive, from the MnS consumer, an ML training request comprising training requirements; evaluate whether a new FL process is to be started based on the training requirements; and in response to a determination to start the new FL process act as a FL server for the new FL process and select appropriate FL clients for the new FL process.

In Example 9, the subject matter of Example 8 includes, wherein the training requirements comprises at least one of minimum number of FL clients, minimum number of total iterations for an ML model used by each FL client for the new FL process, minimum number of data samples for each iteration used by each FL client for the new FL process, or training duration used by each FL client.

In Example 10, the subject matter of Examples 1-9 includes, wherein the processor further configures the apparatus to: receive, from the MnS consumer, a query for performance of the global ML model; send, to the MnS consumer, the performance of the global ML model in response to the query; receive, from the MnS consumer in response to the performance of the global ML model not satisfying predetermined performance characteristics, updated criteria for at least one of selection of FL clients or performance parameters; and use the updated criteria to revise the FL.

Example 11 is an apparatus of a management service (MnS) consumer, the apparatus comprising a processor that configures the apparatus to: send, to an MnS producer, a query for performance of a global machine learning (ML) model aggregated by a Federated Learning (FL) server from a plurality of local ML models each generated by a different FL client; receive, from the MnS producer, performance of the global ML model in response to the query; determine whether a performance of the global ML model satisfies predetermined performance characteristics; and in response to a determination that the performance of the global ML model does not satisfy the predetermined performance characteristics, send updated criteria to the MnS producer, the updated criteria comprising at least one of selection of FL clients or ML performance parameters.

In Example 12, the subject matter of Example 11 includes, wherein the processor further configures the apparatus to receive, from the MnS producer, an identification and a role of each of the FL clients and the FL server.

In Example 13, the subject matter of Examples 11-12 includes, wherein the processor further configures the apparatus to receive, from the MnS producer, characteristics of the FL on first and second training functions to determine whether the global ML model has worse performance than an expected performance and update the criteria in response to the global ML model having worse performance than the expected performance.

In Example 14, the subject matter of Examples 11-13 includes, wherein the processor further configures the apparatus to: receive, from the MnS producer, ML information that includes model performance in different ML phases, energy consumption and resource usage, and send, to the MnS producer, instructions to control a frequency of model exchange between the FL clients and the FL server based on the ML information.

In Example 15, the subject matter of Examples 11-14 includes, wherein the processor further configures the apparatus to send, to the MnS producer, an ML training request comprising training requirements for evaluation of whether a new FL process is to be started and selection of appropriate FL clients for the new FL process.

In Example 16, the subject matter of Example 15 includes, wherein the training requirements comprises at least one of minimum number of FL clients, minimum number of total iterations for an ML model used by each FL client for the new FL process, minimum number of data samples for each iteration used by each FL client for the new FL process, or training duration used by each FL client.

Example 17 is a non-transitory computer-readable storage medium that stores instructions for execution by one or more processors of an apparatus of a management service (MnS) producer, the instructions, when executed, cause the apparatus to: provide a management service to an MnS consumer to manage Federated Learning (FL) for a 5th generation system (5GS), the FL supported by a first machine learning (ML) training function acting as an FL server and a plurality of second training functions acting as FL clients, the FL clients configured to generate local ML models and provide the local ML models to the FL server, the FL server configured to generate a global ML model based on the local ML models and provide the global ML model to the FL clients for further training to produce revised local ML models, wherein the management service includes, providing to the MnS consumer an identification and a role of each of the first ML training function and second ML training functions.

In Example 18, the subject matter of Example 17 includes, wherein the instructions, when executed, cause the apparatus to provide, to the MnS consumer, characteristics of FL on the first and second ML training functions to revise the FL in response to the global ML model having worse performance than an expected performance.

In Example 19, the subject matter of Examples 17-18 includes, wherein the instructions, when executed, cause the apparatus to: provide, to the MnS consumer, ML information that includes model performance in different ML phases, energy consumption and resource usage, and receive, from the MnS consumer, instructions to control a frequency of model exchange between the FL clients and the FL server based on the ML information.

In Example 20, the subject matter of Examples 17-19 includes, wherein the instructions, when executed, cause the apparatus to: receive, from the MnS consumer, a query for performance of the global ML model; send, to the MnS consumer, the performance of the global ML model in response to the query; receive, from the MnS consumer in response to the performance of the global ML model not satisfying predetermined performance characteristics, updated criteria for at least one of selection of FL clients or performance parameters; and use the updated criteria to revise the FL.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus of a management service (MnS) producer, the apparatus comprising a processor that configures the apparatus to:
provide a management service to an MnS consumer to manage Federated Learning (FL) for a 5^{th} generation system (5GS), the FL supported by a first machine learning (ML) training function acting as an FL server and a plurality of second training functions acting as FL clients, the FL clients configured to generate local ML models and provide the local ML models to the FL server, the FL server configured to generate a global ML model based on the local ML models and provide the global ML model to the FL clients for further training to produce revised local ML models,
wherein the management service includes providing to the MnS consumer an identification and a role of each of the first ML training function and second ML training functions.

2. The apparatus of claim 1, wherein the MnS producer is disposed in at least one of the first or second ML training function.

3. The apparatus of claim 1, wherein the MnS producer is disposed in a management function that manages at least one of the first or second ML training functions.

4. The apparatus of claim 1, wherein the processor further configures the apparatus to provide, to the MnS consumer, characteristics of the FL on the first and second ML training functions to revise the FL in response to the global ML model having worse performance than an expected performance running on a local data set on at least one FL client.

5. The apparatus of claim 1, wherein the processor further configures the apparatus to:
provide, to the MnS consumer, ML information that includes model performance in different ML phases, energy consumption and resource usage, and
receive, from the MnS consumer, instructions to control a frequency of model exchange between the FL clients and the FL server based on the ML information.

6. The apparatus of claim 1, wherein the processor further configures the apparatus to expose, to the MnS consumer, capabilities for managing the FL that include obtaining information about whether a particular ML training function is involved in FL and a role of the particular ML training function in the FL.

7. The apparatus of claim 1, wherein the processor further configures the apparatus to expose, to the MnS consumer, capabilities for managing the FL that include obtaining relations between the first ML training function and the second ML training functions in the FL.

8. The apparatus of claim 1, wherein the processor further configures the apparatus to:
receive, from the MnS consumer, an ML training request comprising training requirements;
evaluate whether a new FL process is to be started based on the training requirements; and
in response to a determination to start the new FL process act as a FL server for the new FL process and select appropriate FL clients for the new FL process.

9. The apparatus of claim 8, wherein the training requirements comprises at least one of minimum number of FL clients, minimum number of total iterations for an ML model used by each FL client for the new FL process, minimum number of data samples for each iteration used by each FL client for the new FL process, or training duration used by each FL client.

10. The apparatus of claim 1, wherein the processor further configures the apparatus to:
receive, from the MnS consumer, a query for performance of the global ML model;
send, to the MnS consumer, the performance of the global ML model in response to the query;
receive, from the MnS consumer in response to the performance of the global ML model not satisfying predetermined performance characteristics, updated criteria for at least one of selection of FL clients or performance parameters; and
use the updated criteria to revise the FL.

11. An apparatus of a management service (MnS) consumer, the apparatus comprising a processor that configures the apparatus to:
send, to an MnS producer, a query for performance of a global machine learning (ML) model aggregated by a Federated Learning (FL) server from a plurality of local ML models each generated by a different FL client;
receive, from the MnS producer, performance of the global ML model in response to the query;
determine whether a performance of the global ML model satisfies predetermined performance characteristics; and
in response to a determination that the performance of the global ML model does not satisfy the predetermined performance characteristics, send updated criteria to the MnS producer, the updated criteria comprising at least one of selection of FL clients or ML performance parameters.

12. The apparatus of claim 11, wherein the processor further configures the apparatus to receive, from the MnS producer, an identification and a role of each of the FL clients and the FL server.

13. The apparatus of claim 11, wherein the processor further configures the apparatus to receive, from the MnS producer, characteristics of the FL on first and second training functions to determine whether the global ML model has worse performance than an expected performance and update the criteria in response to the global ML model having worse performance than the expected performance.

14. The apparatus of claim 11, wherein the processor further configures the apparatus to:
receive, from the MnS producer, ML information that includes model performance in different ML phases, energy consumption and resource usage, and
send, to the MnS producer, instructions to control a frequency of model exchange between the FL clients and the FL server based on the ML information.

15. The apparatus of claim 11, wherein the processor further configures the apparatus to send, to the MnS producer, an ML training request comprising training requirements for evaluation of whether a new FL process is to be started and selection of appropriate FL clients for the new FL process.

16. The apparatus of claim 15, wherein the training requirements comprises at least one of minimum number of FL clients, minimum number of total iterations for an ML model used by each FL client for the new FL process, minimum number of data samples for each iteration used by each FL client for the new FL process, or training duration used by each FL client.

17. A non-transitory computer-readable storage medium that stores instructions for execution by one or more processors of an apparatus of a management service (MnS) producer, the instructions, when executed, cause the apparatus to:
provide a management service to an MnS consumer to manage Federated Learning (FL) for a 5^{th} generation system (5GS), the FL supported by a first machine learning (ML) training function acting as an FL server and a plurality of second training functions acting as FL clients, the FL clients configured to generate local ML models and provide the local ML models to the FL server, the FL server configured to generate a global ML model based on the local ML models and provide the global ML model to the FL clients for further training to produce revised local ML models,
wherein the management service includes providing to the MnS consumer an identification and a role of each of the first ML training function and second ML training functions.

18. The non-transitory computer-readable storage medium of claim 17, wherein the instructions, when executed, cause the apparatus to provide, to the MnS consumer, characteristics of FL on the first and second ML training functions to revise the FL in response to the global ML model having worse performance than an expected performance.

19. The non-transitory computer-readable storage medium of claim 17, wherein the instructions, when executed, cause the apparatus to:
provide, to the MnS consumer, ML information that includes model performance in different ML phases, energy consumption and resource usage, and
receive, from the MnS consumer, instructions to control a frequency of model exchange between the FL clients and the FL server based on the ML information.

20. The non-transitory computer-readable storage medium of claim 17, wherein the instructions, when executed, cause the apparatus to:
receive, from the MnS consumer, a query for performance of the global ML model;
send, to the MnS consumer, the performance of the global ML model in response to the query;
receive, from the MnS consumer in response to the performance of the global ML model not satisfying predetermined performance characteristics, updated criteria for at least one of selection of FL clients or performance parameters; and
use the updated criteria to revise the FL.
